(19) United States
(12) Patent Application Publication
(10) Pub. No.: US 2004/0189178 A1
(43) Pub. Date: Sep. 30, 2004

(54) Strip-type mask assembly for color cathode-ray tube

(76) Inventors: Hisakazu Yamane, Tokyo (JP); Haruo Watanuki, Tokyo (JP)

Correspondence Address: BIRCH STEWART KOLASCH & BIRCH, PO BOX 747, FALLS CHURCH, VA, 22040-0747, US

(21) Appl. No.: 10/737,842

(22) Filed: Dec. 18, 2003

(30) Foreign Application Priority Data
Mar. 28, 2003 (JP) 2003-089648

(51) Int. Cl. H01J 29/81; H01J 29/07

(52) U.S. Cl. 313/402; 313/403

(57) ABSTRACT

A strip-type mask assembly includes a strip-type mask having slits and strips. The strip-type mask further has perforations aligned with at least one of the slits and is disposed in at least one of regions between the extreme ends of the slits and the weld lines. The distance between the perforation and the extreme end of the slit is less than or equal to 2 mm. The dimensions and the positions of the perforations, and the number of the perforations aligned with one slit are determined so as to reduce the difference among the widths of the slits resulting from the local variation of the distribution of the tension on the slits or the difference among the lengths of the slits.

### BACKGROUND OF THE INVENTION

1. Field of the Invention

The present invention relates to a color selection mask assembly used in a color cathode ray tube, and particularly to a strip-type mask assembly that has a large number of slits for the passage of electron beams and a large number of strips separating the slits from each other, and has few or no bridges extending across the slits to connect the strips.

2. Description of the Related Art

A conventional strip-type mask assembly has a structure in which a mask is stretched over a mask frame, and therefore has a problem that creases may be formed on the mask due to the nonuniform distribution of tension applied to the mask. In order to solve the problem, a plurality of projections are formed on the mask between extreme ends of slits and weld lines at which the mask is welded to the mask frame. When the creases are found after the mask is welded to the mask frame, the projections corresponding to the creases are selectively removed by laser beam or the like. By removing the projections, openings are formed on the mask so as to prevent the concentration of the stress due to the tension on the mask, and therefore the creases can be eliminated (see, for example, patent reference 1).

Another conventional strip-type mask assembly is intended to suppress the discontinuous variation of the widths of end slits closest to the ends of a slit region (i.e., a region in which the slits are arranged) in a horizontal direction in which the slits are arranged. The widths of the end slits may vary when the tension on the mask has a distribution, and particularly when the tension on the end slits is different from the tension on the other slits. In the strip-type mask assembly, the mask has extra slits formed on the outside of the slit region in the horizontal direction. The extra slits are narrower than the slits in the slit region, and do not allow the passage of electron beams. By the provision of the end slits, the width of the end slits can be kept constant (see, for example, patent reference 2 and 3).

Still another conventional strip-type mask assembly is intended to prevent the striped unevenness that occurs when the strips of the mask are twisted due to a creep at high temperature during the heat treating process. In the strip-type mask assembly, perforations are formed on peripheral regions of the mask between the slit region and the weld lines. By the provision of the perforations, the cross sectional area of each peripheral region per unit length in the horizontal direction becomes smaller than that of the slit region, and therefore the rigidity of the peripheral region becomes smaller than that of the slit region to thereby suppress the striped unevenness (see, for example, patent reference 4).

### PATENT REFERENCE

1. Japanese Unexamined Patent Application Publication No. HEI 05-347129 (FIG. 1)

2. Japanese Patent Publication No.3158297 (FIG. 1)

3. Japanese Patent Publication No.3194290 (FIG. 1)

4. Japanese Unexamined Patent Application Publication No. 2001-167711 (FIG. 1)

When vibration is transferred to the mask from outside, there is a possibility that all the strips resonate and cause the vibration of the entire screen. Thus, it is necessary that the natural frequencies of the strips of the mask are different from each other, in order to suppress the resonance of the strips. As the natural frequencies of the strips are pertinent to tension applied to the strips, there is provided a distribution of the tension applied to the mask. For example, the tension applied to the center of the mask is different from the tension applied to the end of the mask, so that natural frequency of the strip at the center of the mask is different from that of the strip at the end of the mask.

In addition to the above described distribution of the tension on the strips, the tension may further locally vary in a process in which the mask is stretched over the mask frame. In such a case, there is a difference among shrinkage forces (i.e., the Poisson contraction) of the strips acting in the horizontal direction.

Further to the difference among the shrinkage forces of the strips, the difference among the lengths of the slits may cause bending moments on the strips in the direction of bending the strips. Due to the bending moments on the strips, the widths of the slits may discontinuously vary, and may cause the unevenness on a phosphor screen so that the image quality may be degraded. The unevenness caused by the difference among the widths of the slits is referred to as pitch unevenness. The pitch unevenness tends to appear easily at the ends of the mask in the horizontal direction, compared to the center of the mask in the horizontal direction.

According to the strip-type mask assembly proposed by patent reference 1, the creases (i.e., the deformation of the mask in the direction perpendicular to the surface of the mask) are eliminated by forming the openings on the mask by means of a relatively complicated method using laser beam or the like so as to prevent the concentration of the stress. However, it is difficult to prevent the pitch unevenness resulted from the local variation of the distribution of the tension (at a relatively low level at which the creases are not formed) or the difference among the lengths of the slits.

According to the strip-type mask assemblies proposed by patent references 2 and 3, the fine extra slits having the width preventing the passage of the electron beams are formed on the outside of the slit region in the horizontal direction, and relieve the tension on the end portions of the slit region in the horizontal direction for reducing the pitch unevenness. Such an arrangement is effective in suppressing the variation of the widths of the end slits or several slits in the end portions of the slit region, but is not effective in suppressing the pitch unevenness resulted from the local variation of the distribution of the tension on the mask or the difference among the lengths of the slits.

According to the strip-type mask assembly proposed by patent reference 4, the twisting of the strips due to creep at high temperature can be prevented by reducing the rigidity of the peripheral regions of the mask. However, such an arrangement is not effective in suppressing the pitch unevenness resulted from the local variation of the distribution of the tension on the mask or the difference among the lengths of the slits.

### SUMMARY OF THE INVENTION

An object of the present invention is to provide a strip-type mask assembly for a color cathode ray tube capable of enhancing the image quality by suppressing the pitch unevenness caused by the local variation of the distribution of the tension on a mask and the difference among the lengths of slits of the mask.

According to the present invention, there is provided a strip-type mask assembly for a color cathode ray tube including a color selection mask and a mask frame. The color selection mask has a plurality of parallel slits for the passage of electron beams and a plurality of strips separating the slits from each other. The mask frame supports the color selection mask in such a manner that the mask frame applies tension to the color selection mask. The color selection mask is welded to the mask frame at weld positions on both ends of the color selection mask in the longitudinal direction of the slits. The color selection mask has at least one perforation aligned with at least one of the slits in said longitudinal direction. The perforation is provided in at least one of regions between extreme ends of the slits and the weld positions to form a partition between each perforation and an extreme end of the corresponding slit. The dimension of each partition in said longitudinal direction is less than or equal to 2 mm.

With such an arrangement, it is possible to reduce the difference among the widths of the slits caused by the local variation of the distribution of the tension or the difference among the lengths of the slits. Thus, the pitch unevenness can be suppressed, and therefore the image quality can be enhanced. These effects are obtained even in the case where the strips have projections for preventing the entanglement of the strips.

### BRIEF DESCRIPTION OF THE DRAWINGS

In the attached drawings:

FIG. 1 is a sectional view of an example of a color cathode ray tube used in television sets or computer monitors;

FIG. 2A is a perspective view of a strip-type mask assembly for the color cathode ray tube according to Embodiment 1;

FIG. 2B is an enlarged view of extreme ends of slits (and strips) of the strip-type mask assembly shown in FIG. 2A;

FIG. 3A is a perspective view illustrating a strip-type mask assembly of the related art;

FIG. 3B is an enlarged view of extreme ends of slits (and strips) of the strip-type mask assembly shown in FIG. 3A;

FIG. 4A is a front view of a mask of the strip-type mask assembly shown in FIG. 3A;

FIG. 4B is an enlarged view of extreme ends of slits (and strips) of the mask shown in FIG. 4A;

FIG. 4C is an enlarged view of the extreme ends of the slits (and the strips) of the mask shown FIG. 4B;

FIG. 4D is a diagram illustrating the distribution of the tension on the mask shown in FIG. 4A;

FIGS. 5A through 5E are schematic views illustrating a principle of the occurrence of the pitch unevenness in the strip-type mask assembly of the related art shown in FIG. 3A;

FIG. 6A is a front view of a mask in the strip-type mask assembly according to Embodiment 1 shown in FIG. 2A;

FIG. 6B is an enlarged view of extreme ends of slits (and strips) of the mask shown in FIG. 6A;

FIGS. 7A through 7E are schematic views illustrating a principle of the prevention of the pitch unevenness in the strip-type mask assembly shown in FIGS. 6A and 6B;

FIG. 8A is a diagram illustrating the relationship between the distance from the slit to a perforation and the difference among shrinkage forces of the strips when there is a local variation of the distribution of the tension on the strips;

FIG. 8B is a diagram illustrating the relationship between the distance from the slit to the perforation and the bending moments on the strips when there is a difference among the lengths of the strips;

FIG. 9A is a front view of a mask of a strip-type mask assembly for a color cathode ray tube according to Embodiment 2;

FIG. 9B is an enlarged view of extreme ends of slits (and strips) of the mask shown in FIG. 9A;

FIGS. 10A through 10C respectively illustrate examples of relationships between the slits, strips and perforations in Embodiment 2;

FIG. 11A is a front view of a mask of a strip-type mask assembly for a color cathode ray tube according to Embodiment 3;

FIG. 11B is an enlarged view of extreme ends of slits (and strips) of the mask shown in FIG. 11A;

FIG. 12 is a cross sectional view of a strip-type mask assembly for a color cathode ray tube according to Embodiment 4;

FIGS. 13A and 13B are enlarged cross sectional views of a portion including a perforation of the strip-type mask assembly shown in FIG. 12;

FIG. 14A is a perspective view of a strip-type mask assembly for a color cathode ray tube according to Embodiment 5;

FIG. 14B is an enlarged view of extreme ends of slits (and strips) in the strip-type mask assembly shown in FIG. 14A;

FIG. 15A is a front view of a mask of a strip-type mask assembly for a color cathode ray tube according to Embodiment 6;

FIG. 15B is an enlarged view of extreme ends of slits (and strips) and circular perforations in the mask shown in FIG. 15A; and

FIG. 15C is an enlarged view of extreme ends of slits (and strips) and rhomboid perforations in the mask shown in FIG. 15A.

### DETAILED DESCRIPTION OF THE INVENTION

Embodiments of the present invention will be described with reference to the attached drawings.

Embodiment 1

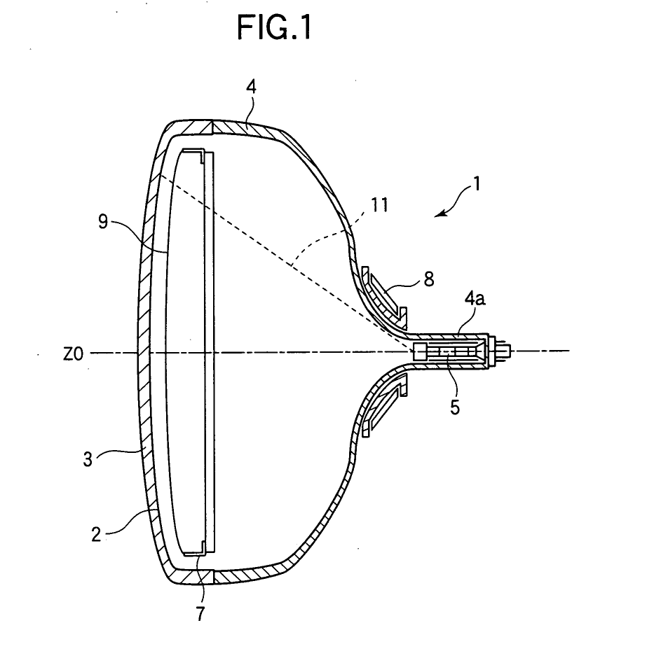

FIG. 1 is a cross sectional view of an example of a color cathode ray tube to which a strip-type mask assembly according to Embodiment 1 can be employed. The color cathode ray tube is used in television sets or computer monitors.

As shown in FIG. 1, the color cathode ray tube 1 includes a face plate 3 having a phosphor screen 2 formed on the inner side thereof, a funnel 4 connected to the rear end of the face plate 3, electron guns 5 provided in a neck portion 4a of the funnel 4, a color selection mask 9 (hereafter simply referred to as a mask) provided inside the face plate 3, and a mask frame 7 supporting the mask 9 so that the mask 9 faces the phosphor screen 2.

The mask 9 has a color selection function that makes three electron beams 11 emitted from the electron guns 5 incident on red, green, and blue phosphors. A deflection yoke 8 deflects the electron beams 11 so as to scan the phosphor screen 2. FIG. 1 shows an example of traces of the electron beams 11 deflected by the deflection yoke 8. A tube axis Z0 is defined as an axis connecting the center of the phosphor screen 2 and the electron guns 5 in the color cathode ray tube 1.

The mask 9 is formed by selectively etching a thin metal sheet to form a large number of slits (or slot holes) for the passage of electron beams. A bridge-type and a strip-type are known as representative structures of the mask. The bridge-type mask has a large number of strips arranged at constant intervals, and a large number of bridges connecting the strips to form rectangular slot holes for the passage of electron beams. In contrast, the strip-type mask has a large number of strips but has few or no bridges. In the strip-type mask, fine slits for the passage of electron beams are formed between the strips. The mask 9 of Embodiment 1 is of the strip-type.

The strip-type mask is superior to the bridge-type mask in heat resistance. The strip-type mask is stretched over the mask frame so that a tension is applied to the mask in the longitudinal direction of the strips, and has few or no bridges connecting the strips across the slits. This structure is effective in preventing the thermal expansion of the mask. Thus, a dooming phenomenon caused by the thermal expansion of the mask can be prevented, and therefore a color shift due to the dooming phenomenon can be prevented.

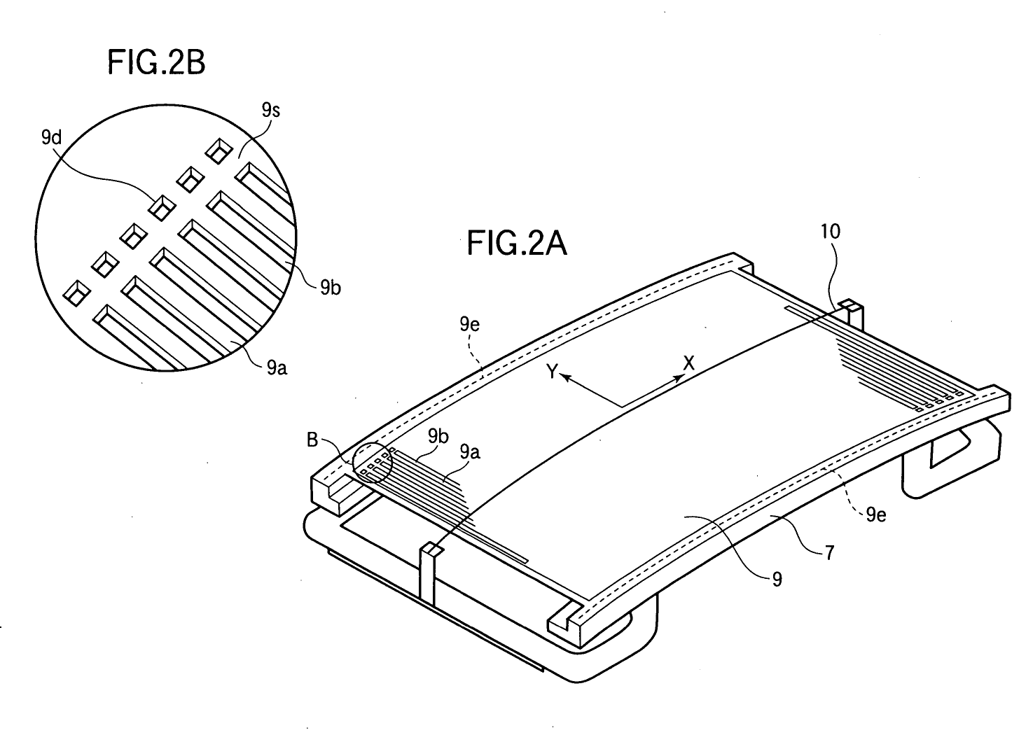

FIG. 2A is a perspective view of the strip-type mask assembly for the color cathode ray tube of Embodiment 1, illustrating the relationship between the mask 9 and the mask frame 7. FIG. 2B is an enlarged view of extreme ends (upper ends or lower ends) of slits (and strips) as indicated by a circle B in FIG. 2A.

As shown in FIG. 2A, the mask 9 has a number of strips 9a arranged at constant intervals in the X-direction, i.e., the horizontal direction. Each strip 9a is elongated in the Y-direction (i.e., the vertical direction) perpendicular to the X-direction. A number of slits 9b are formed between adjacent strips 9a. Peripheral regions on both ends of the mask 9 in the Y-direction are welded onto the mask frame 7 so that tension is applied to the mask 9 in the Y-direction (i.e., the longitudinal direction of the slits 9b). The positions at which the mask 9 is welded onto the mask frame 7 are indicated by weld lines 9e. The mask 9 and the mask frame 7 constitute a strip-type mask assembly.

In the mask 9 shown in FIG. 2A, the strips 9a has few or no bridges, and tension is applied to the mask 9 at the peripheral regions of the mask 9. Thus, the strips 9a of the mask 9 may vibrate because of vibrations transferred from a vibration source such as a speaker. The vibration may cause the displacement of the landing position of the electron beams 11 (FIG. 1) on the phosphor screen 2, and may result in the color shift on the phosphor screen 2. The vibration of the strips 9a is suppressed by a damper wire 10 made of a tungsten or the like stretched in the X-direction so that the wire 10 contacts the strips 9a. Even when the vibration is transferred to the strips 9a from outside, the vibration of the strips 9a is reduced by the friction between the damper wire 10 and the strips 9a, so that the color shift on the phosphor screen 2 can be prevented.

As shown in FIGS. 2A and 2B, the mask 9 has perforations (or at least one perforation) 9d aligned with the slits 9b in the longitudinal direction of the slits 9b (i.e., the Y-direction) and between the extreme ends of the slits 9b and the weld lines 9e. A partition 9s is defined between the perforation 9d and the slit 9b.

The description is made to a strip-type mask assembly of the related art, in order to clarify the difference between the strip-type mask assembly of Embodiment 1 and the related art.

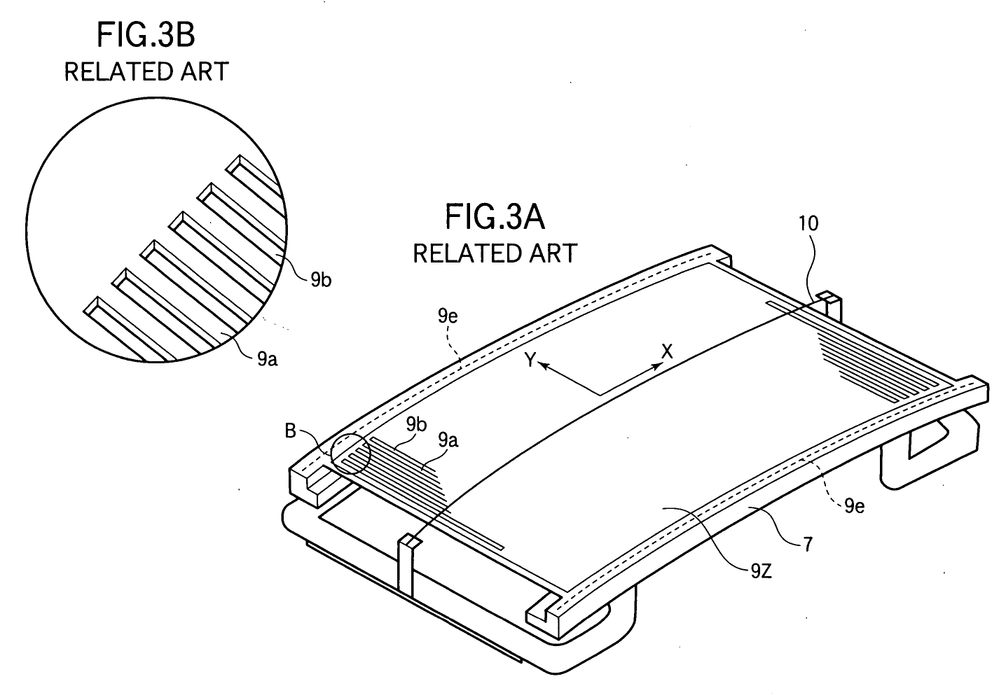

FIG. 3A is a perspective view of the strip-type mask assembly of the related art. FIG. 3B is an enlarged view of extreme ends of the slits (and strips) as indicated by a circle B in FIG. 3A. In FIGS. 3A and 3B, the reference numeral 9z indicates a mask in the strip-type mask assembly of the related art. The mask frame, the damper wire, the weld lines, the strips and the slits in the strip-type mask assembly of the related art are assigned the same reference numerals as those of Embodiment 1.

In the mask 9z of the related art, it is necessary that the respective strips 9a have different natural frequencies in order to prevent the resonance of all the strips 9a and to prevent the vibration of the entire screen when the vibration is transferred to the strips 9a from outside. The natural frequencies of strips 9a are pertinent to the tension applied to the strips 9a.

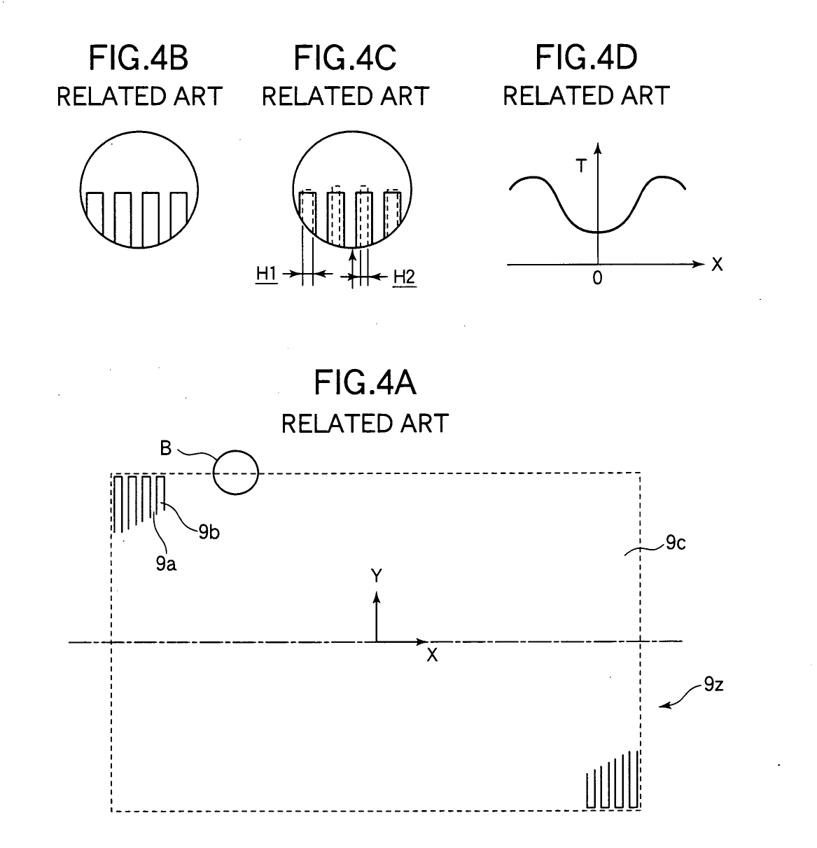

FIG. 4A is a front view of the mask 9z of the strip-type mask assembly of the related art shown in FIG. 3A. FIG. 4B is an enlarged view of extreme ends of the slits 9b (and the strips 9a) as indicated by a circle B in FIG. 4A. FIG. 4C schematically illustrates the variation of the widths of the slits 9b. FIG. 4D is a diagram illustrating the distribution of the tension on the mask 9z.

In FIG. 4C, the reference numeral 9c indicates a slit region in the mask 9z of the related art. In FIG. 4D, the X-axis indicates the position along the X-direction (FIG. 3), and the Y-axis indicates the tension on the mask 9z. The tension on the strips 9a of the mask 9z has the distribution shown in FIG. 4D, with the result that the natural frequencies of the strips 9a have substantially the same distribution, and therefore the resonance of the whole strips 9a at the same frequency can be prevented.

In the mask 9z of the related art shown in FIG. 4A, in addition to the distribution of the tension shown in FIG. 4D, the tension on the strips 9a may further locally vary in a stretching process of the mask 9z. Thus, there is a difference among the shrinkage forces of the strips 9a in the X-direction (i.e., Poisson contraction). In addition to the difference among the shrinkage forces of the strips 9a in the X-direction, bending moments are applied to the strips 9a in the direction of bending the strips 9a, when there is a difference among the lengths of the slits 9b. As a result, the widths of the slits 9b may discontinuously vary, and may cause the unevenness on the phosphor screen and degrade the image quality. The unevenness caused by the difference among the widths of the slits 9b is referred to as pitch unevenness. The end portions of the mask 9z in the X-direction are more susceptible to the pitch unevenness than the center of the slit region 9c.

FIG. 4B illustrates the widths of the slits 9b before the mask 9z is stretched. FIG. 4C illustrates the widths of the slits 9b after the mask 9z is stretched. Before the mask 9z is stretched, the widths of the slits 9b are similar to each other as shown in FIG. 4B. However, after the mask 9z is stretched, the widths of the slits 9b are not similar to each other as indicated by references H1 and H2 (H1≠H2) in FIG. 4C because of the local variation of the distribution of the tension and the difference among the lengths of the slits 9b. The variation of the widths of the slits 9b causes the pitch unevenness, and degrades the image quality.

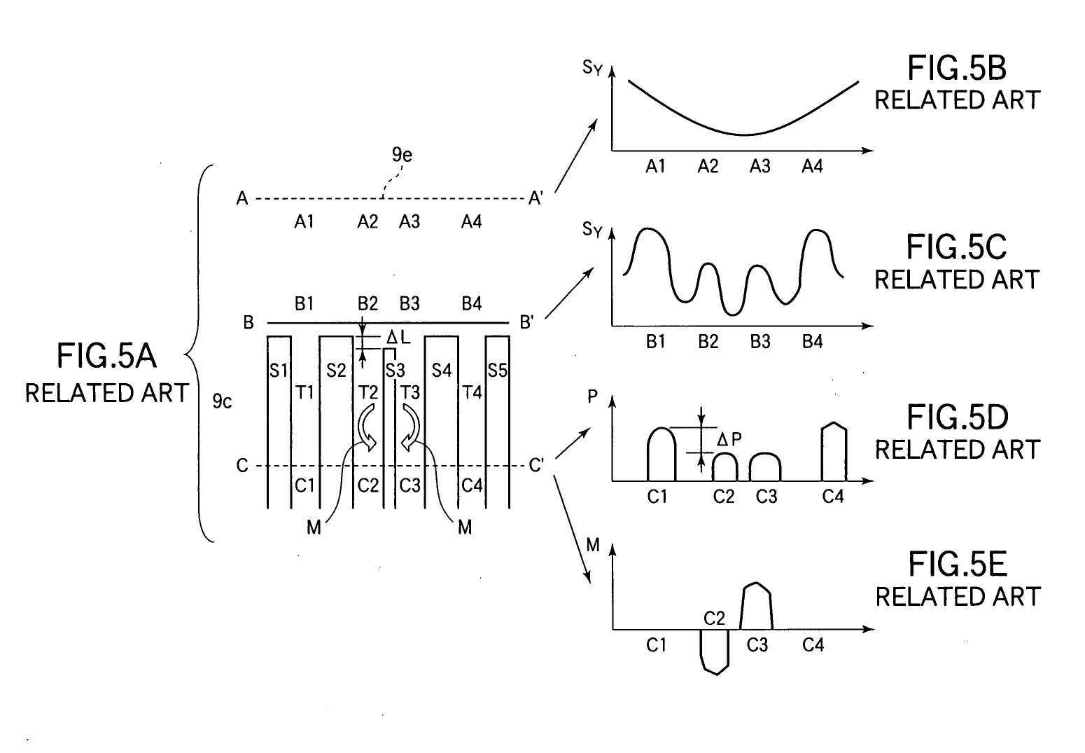

FIG. 5A illustrates the principle of the occurrence of the pitch unevenness in the strip-type mask assembly of the related art shown in FIGS. 3A and 4A. In FIG. 5A, the reference numerals S1 through S5 indicate arbitrary slits 9b in the slit region 9c, and the reference numerals T1 through T4 indicate the strips 9a respectively defined between the slits S1 through S5. A dash line A-A′ indicates the weld line 9e at which the type mask 9z (FIG. 3A) is welded to the mask frame. FIG. 5B illustrates the distribution of the stress in the Y-direction (Sy) along the line A-A′. FIG. 5C illustrates the distribution of the stress in the Y-direction (Sy) along the line B-B′ in the vicinity of the extreme ends of the slits S1 through S5.

Under the assumption that the distribution of the stress on the mask 9z along the weld line 9e locally varies in the stretching process as shown in FIG. 5B, the distribution of the stress along the line B-B′ in the vicinity of the ends of the slits S1 through S5 is as shown in FIG. 5C. In FIG. 5C, the stress at positions B1 and B4 corresponding to the strips T1 and T4 is greater than the stress at positions B2 and B3 corresponding to the strips T2 and T3.

As a result, there is a difference among the shrinkage forces (in the X-direction) of the strips T1 through T4 on line C-C′ (FIG. 5A) in the slit region 9c. FIG. 5D illustrates the shrinkage force P in the X-direction at positions C1 through C4 on the strips T1 through T4. In FIG. 5D, there is a difference ΔP between the shrinkage force (in the X-direction) at the positions C1 and C4 on the strips T1 and T4 and the shrinkage force (in the X-direction) at the positions C2 and C3 on the strips T2 and T3.

In addition to the above described difference ΔP, in the case where the lengths of the slits S2 and S4 are longer than the length of the slit S3 by the difference ΔL as shown in FIG. 5A, the bending moments M are applied to the strips T2 and T3 as shown in FIG. 5E in the direction of widening the slits S2 and S4 and narrowing the slit S3 as shown in FIG. 5A. Because of the combination of the bending moments M and the difference ΔP among the shrinkage forces of the strips 9a in the X-direction, the slits S2 and S4 are widened and the slit S3 are narrowed as shown in FIG. 5A. The difference among the widths of the slits 9b may result in the pitch unevenness on the screen and may degrade the image quality.

In contrast, according to Embodiment 1 shown in FIG. 2A, the mask 9 has the perforations 9d aligned with the slits 9b in the Y-direction and disposed between the extreme ends of the slits 9b and the weld lines 9e. The distance between the perforation 9d and the extreme end of the slit 9b is within a certain range as described later. The perforation 9d can be provided for all slits 9b, or for a part of slits 9b.

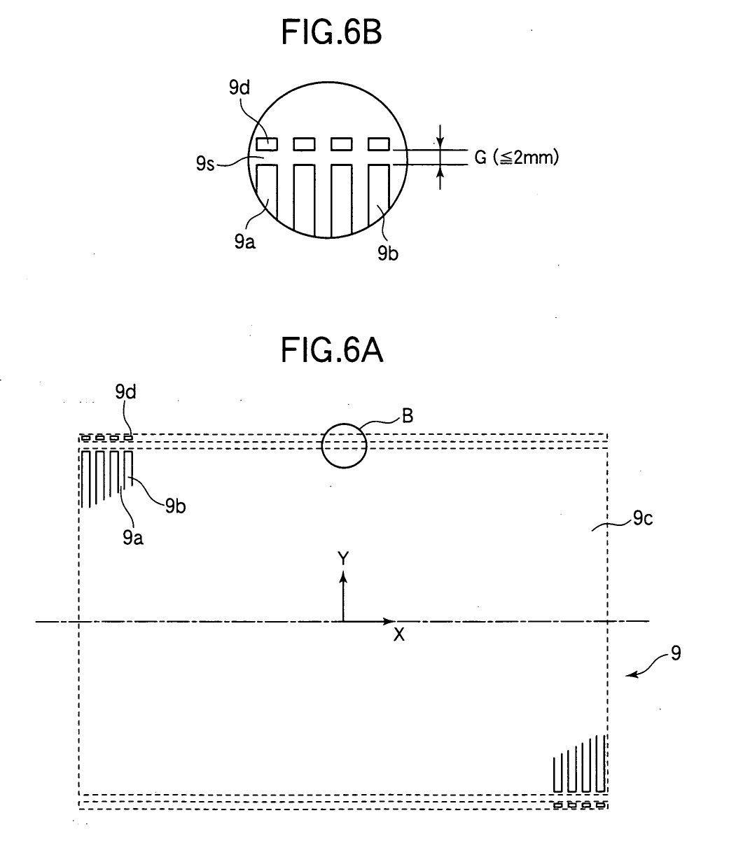

FIG. 6A is a front view of the mask 9 according to Embodiment 1 shown in FIG. 2A. FIG. 6B is an enlarged view of the extreme ends of the slits 9b (and the strips 9a) as indicated by a circle B in FIG. 6A. If the mask 9 has no perforations 9d, the stress having the distribution (FIG. 4D) is directly applied to the slits 9b, so that the difference ΔP among shrinkage forces of the strips 5a (FIG. 5D) in the X-direction is generated. Further, if there is a difference among the lengths of the slits 5b, the bending moments M (FIG. 5A) are generated on the strips 5a without being relieved. In contrast, according to Embodiment 1 shown in FIG. 6A, the stress is first applied to the perforations 9d, and the perforations 9d are deformed so as to relieve the stress and to thereby reduce the stress applied to the slit 9b.

Compared with the length (i.e., the dimension in the Y-direction) of the slit 9b, the dimension of the perforation 9d is relatively small. As the distance between the perforation 9d and the extreme end of the slit 9b increases, the periphery of the perforation 9d becomes resistant to deformation and decreases the effect of relieving the stress. Therefore, in the strip-type mask assembly of Embodiment 1, the perforation 9d is disposed within 2 mm from the extreme end of the slit 9b and is aligned with the slit 9b in the Y-direction as shown in FIG. 6B. The distance (within 2 mm) between the perforation 9d and the slit 9b corresponds to the width of the partition 9s between the perforation 9d and the slit 9b.

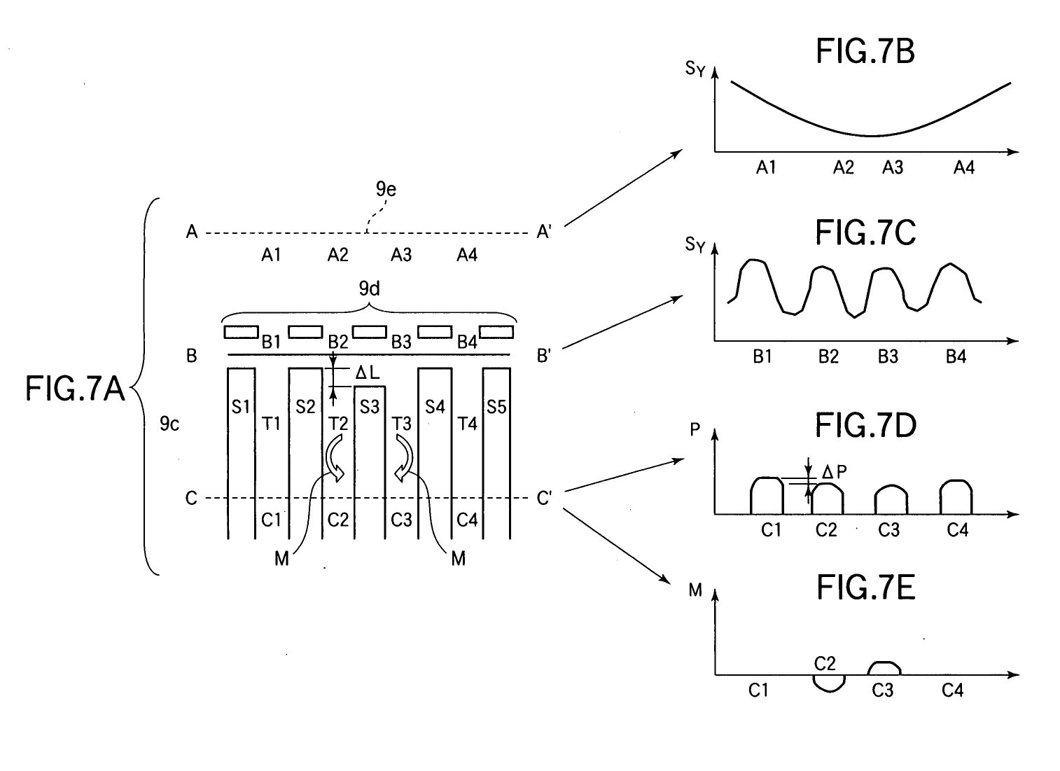

FIGS. 7A through 7E illustrate a mechanism for suppressing the pitch unevenness in the strip-type mask assembly according to Embodiment 1.

In FIG. 7A, the reference numerals S1 through S5 indicate arbitrary slits 9b, and the reference numerals T1 through T4 indicate strips 9a between the slits S1 through S5. The line A-A′ indicates the weld line 9e at which the mask 9 is welded to the mask frame 7 (FIG. 1). FIG. 7B illustrates the distribution of the stress in the Y-direction (Sy) along the line A-A′. FIG. 7C illustrates the distribution of the stress in the Y-direction (Sy) along the line B-B′ in the vicinity of the extreme ends of the slits S1 through S5.

If the distribution of the stress on the weld line 9e locally varies as shown in FIG. 7B in the stretching process or the like, the perforations 9d disposed in the vicinity of the slits S1 through S5 (and aligned with the slits 9b) relieve the stress in the vicinity of the slits S1 through S5. Accordingly, the distribution of the stress on the line B-B′ in the proximity of the slits S1 through S5 is as shown in FIG. 7C. Different from the related art example (FIG. 5C), the curves representing the stress at the positions B1 through B4 have substantially the same waveforms having substantially the same intervals. In other words, the stress at the positions B1 and B4 on the strips T1 and T4 are substantially the same as the stress at the positions B2 and B3 on the strips T2 and T3.

As a result, the difference ΔP between the shrinkage force (in the X-direction) at the positions C1 and C4 and the shrinkage force (in the X-direction) at the positions C2 and C3 becomes smaller than that of the related art example shown in FIG. 5D. Further, because the stress is relieved by the perforations 9d, the bending moments M are reduced as shown in FIG. 7E, in comparison with the bending moments M of the related art example shown in FIG. 5E. Accordingly, both the bending moments M and the difference ΔP among the shrinkage forces of the strips 9a in the X-direction are reduced by the provision of the perforations 9d. Thus, the difference among the widths of the slits 9b decreases, so that the pitch unevenness on the screen can be prevented, and the image quality can be enhanced.

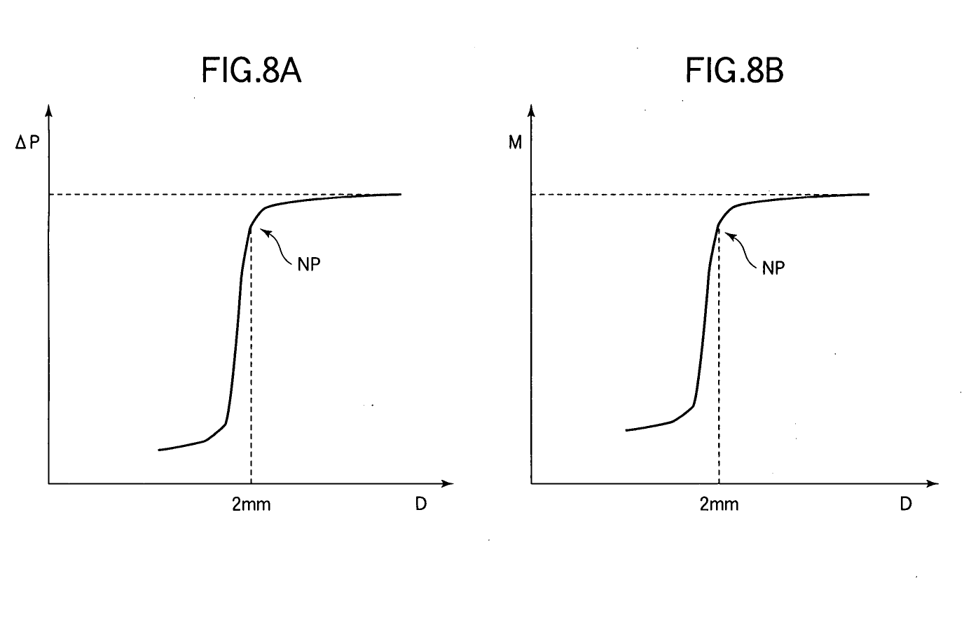

FIG. 8A illustrates the relationship between the distance from the slit 9b to the perforation 9d and the difference ΔP among the shrinkage forces of the strips 9a in the X-direction, when the distribution of the tension locally vary. FIG. 8B illustrates the relationship between the distance from the slit 9b to the perforation 9d and the bending moment M, when there is a difference among the lengths of the slits 9a.

In FIG. 8A, the curve representing the difference ΔP in the shrinkage forces of the strips 9a in the X-direction has a knee point (NP) where the difference ΔP steeply decreases as the distance D from the slit 9b to the perforation 9d falls below a certain value. Similarly, in FIG. 8B, the curve representing the bending moment M has a knee point where the bending moment M steeply decreases as the distance D falls below a certain value. Experiments have shown that the distance D from the slit 9b to the perforation 9d corresponding to the knee point is 2 mm for both of the difference ΔP of shrinkage forces of the strips 9a (FIG. 8A) in the X-direction and the bending moment M (FIG. 8B). This is because both of the difference ΔP among the shrinkage forces of the strips 9a in the X-direction and the bending moment M are reduced because the stress is relieved by the perforation 9d in the vicinity of the slit 9b. Accordingly, the distance between the slit 9b and the perforation 9d must be less than or equal to 2 mm, in order to reduce the difference ΔP among the shrinkage forces of the strips 9a in the X-direction and the bending moment M of the strips 9a.

The above described range of the distance D (less than or equal to 2 mm) between the slit 9b and the extra slit 9d in the Y-direction is obtained by experiments on large cathode ray tubes of 30-inch. The same experiments have proven that it is possible to reduce the difference ΔP among shrinkage forces of the strips 9a in the X-direction and the bending moments M of the strips 9a when the width of the partition 9s is at least 30 μm (0.03 mm). Thus, the effective range of the distance D has been proven to be 0.03 to 2 mm. However, it is presumed that the minimum effect can be obtained even when the distance D is less than 0.03 mm.

Further, it is presumed that the above described upper limit (2 mm) of the distance D depends on the design specifications such as dimensions (for example, length, width and thickness) of the mask 9 and the widths of the slits 9b. However, the above described upper limit may not exceed 2 mm, because the upper limit is obtained from experiments on the cathode ray tubes of 30-inch which are the largest at present.

As described above, the strip-type mask assembly of Embodiment 1 has the perforations 9d, and the distance between each perforation 9d and the extreme end of the respective slit 9b (i.e., the width of the partition 9s) is less than or equal to 2 mm. Therefore, it is possible to reduce the pitch unevenness even when the distribution of the tension locally varies in the manufacturing process, or even when there is the difference among the lengths of the slits 9a. Accordingly, the image quality of the color cathode ray tube can be enhanced.

Embodiment 2

In the above described Embodiment 1, the pitch unevenness is suppressed by providing perforations 9d having the same size and located at the same distance (within 2 mm) from the extreme ends of the slits 9b. In Embodiment 2, the sizes and the positions of the perforations 9d are varied. As the distance between the perforation 9d and the extreme end of the slit 9b (i.e., the width of the partition 9s) increases, the periphery of the perforation 9d becomes resistant to deformation, so that it becomes difficult to relieve the stress by means of the perforation 9d. Further, as the dimension of the perforation 9d decreases, the periphery of the perforation 9d becomes resistant to deformation, so that it becomes difficult to relieve the stress. Therefore, the width 9s and the size of the perforation 9d (for example, the diameter if the perforation 9d has a circular shape, the length or the width if the perforation 9d has a rectangular shape) can be varied as parameters according to the distribution of the tension.

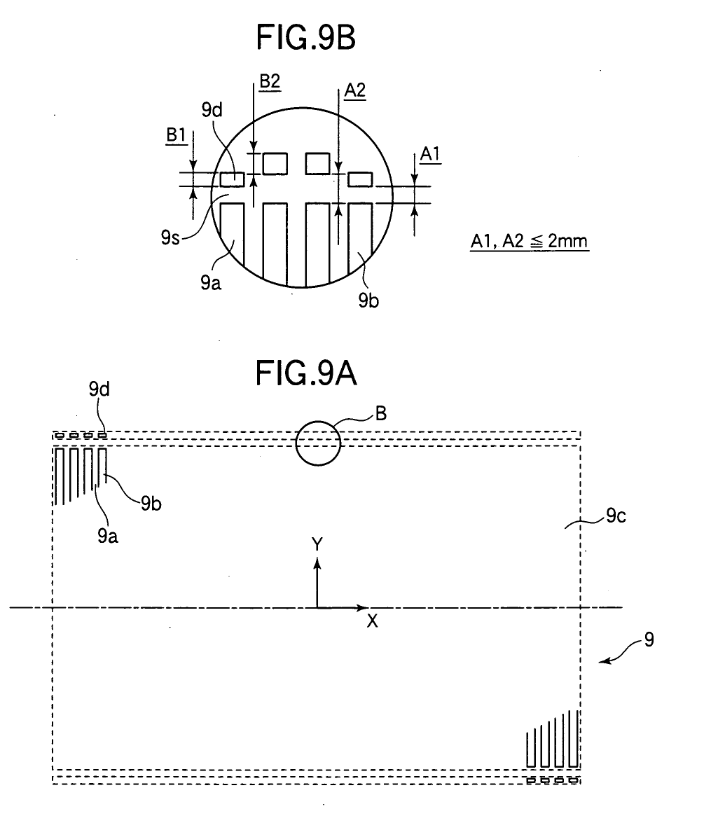

FIG. 9A is a front view of the mask 9 of a strip-type mask assembly for the color cathode ray tube according to Embodiment 2. FIG. 9B is an enlarged view of the extreme ends of the slits 9b (and the strips 9a) as indicated by a circle B in FIG. 9A.

The mask 9 of Embodiment 2 has the perforations 9d aligned with at least a part of slits 9b, as was described in Embodiment 1. The distance from the slit 9b to the perforation 9d is less than or equal to 2 mm. In a portion of the mask 9 where the pitch unevenness is likely to occur, the position of the perforation 9d with respect to the extreme end of the slit 9b (i.e., the width of the partition 9s) or the size of the perforation 9d is varied so as to suppress the pitch unevenness. The size of the perforation 9d is varied by varying the dimension of the perforation 9d in the longitudinal direction of the slit 9b. The other elements in Embodiment 2 are the same as those of Embodiment 1.

In Embodiment 2, the sizes (B1, B2) of the perforations 9d and the positions (A1, A2) of the perforations 9d with respect to the slits 9b are varied, so as to vary the deformability of the peripheries of the perforations 9d for decreasing the difference among the widths of the slits 9b to thereby suppress the pitch unevenness.

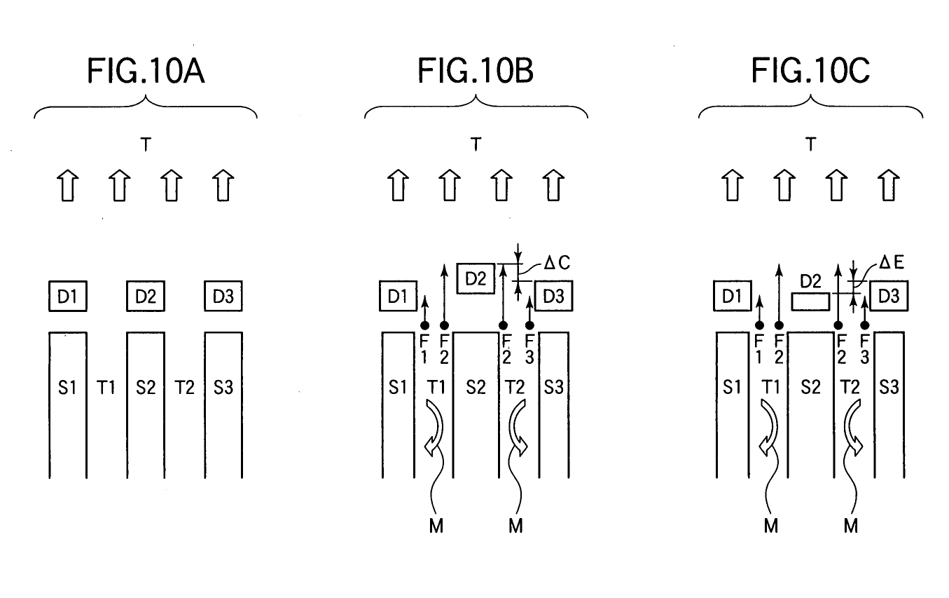

FIGS. 10A through 10C schematically illustrate a mechanism for canceling the bending moment M by varying the positions and the sizes of the perforations 9d. FIG. 10A shows the mask 9 according to Embodiment 1. In FIG. 10A, the reference numerals S1 through S3 indicate arbitrary slits, and the reference numerals T1 and T2 indicate strips between the slits S1 through S3. Openings D1 through D3 are aligned with the slits S1 through S3 in the Y-direction (i.e., the longitudinal direction of the slits S1 through S3). The tension T is applied to the mask 9 as was described in Embodiment 1.

FIG. 10B shows the mask 9 according to Embodiment 2 in which the distance from the slit S2 to the perforation D2 (i.e., the width of the partition 9s) is longer than the distance from the slit S1 or S3 to the perforation D1 or D2 by ΔC.

In FIG. 10B, the tension F2 on the strip T1 in the proximity of the extreme end of the slit S2 is greater than the tension F1 on the strip T1 in the proximity of the extreme end of the slit S1, because the stress relieved by the perforation D2 is smaller than the stress relieved by the perforation D1. Similarly, the tension F2 on the strip T2 in the proximity of the extreme end of the slit S2 is greater than the tension F3 on the strip T2 in the proximity of the extreme end of the slit S3, because the stress relieved by the perforation D2 is smaller than the stress relieved by the perforation D3. Because of the difference between the tension F1 or F3 and the tension F2, the bending moments M are applied to the strips T1 and T2 in the direction of widening the slits S1 and S3 and narrowing the slit S2.

In contrast, if the distance from the slit S2 to the perforation D2 is shorter than the distance from the slit S1 or S3 to the perforation D1 or D3, the bending moments M are applied to the strips T1 and T2 in the direction of widening the slit S2 and narrowing the slits S1 and S3.

In FIG. 10C, the dimension of the perforation D2 in the Y-direction is smaller than the dimensions of the perforations D1 and D3 by ΔE. In FIG. 10C, the tension F2 on the strip T1 in the proximity of the extreme end of the slit S2 is greater than the tension F1 on the strip T1 in the proximity of the extreme end of the slit S1, because the stress relieved by the perforation D2 is smaller than the stress relieved by the perforation D1. Similarly, the tension F2 on the strip T2 in the proximity of the extreme end of the slit S2 is greater than the tension F3 on the strip T2 in the proximity of the extreme end of the slit S3, because the stress relieved by the perforation D2 is smaller than the stress relieved by the perforation D3. Because of the difference between the tension F1 or F3 and the tension F2, the bending moments M are applied to the strips T1 and T2 in the direction of widening the slits S1 and S3 and narrowing the slit S2.

In contrast, if the dimension of the perforation D2 is larger than the dimension of the perforation D1 or D3, the bending moments M are applied to the strips T1 and T2 in the direction of widening the slit S2 and narrowing the slits S1 and S3.

Thus, it is possible to generate the bending moment M by varying the sizes of the perforations 9b or the distance between the perforations D2 (FIGS. 10B and 10C) and the slits S2. Therefore, if the pitch unevenness is caused by the difference among the shrinkage forces of the strips 9a (FIG. 7D) of the X-direction or the difference among the lengths of the slits 9b (FIG. 7E), it is possible to apply the bending moment M to the strips T1 and T2 so as to suppress the pitch unevenness by varying the distance between the perforations D2 and the slits S2 (FIG. 10B) or the sizes of the perforations 9b (FIG. 10C).

As described above, according to the strip-type mask assembly of Embodiment 2, it is possible to suppress the pitch unevenness by varying the positions of the perforations 9d (with respect to the slits 9b) or the sizes of the perforations 9d in the part of the mask 9 where the pitch unevenness is likely to occur, so as to cause the bending moments M in the direction in which the pitch unevenness is suppressed. Thus, in addition to the advantages of Embodiment 1, the pitch unevenness can be further suppressed.

Embodiment 3

In the above described Embodiment 2, the sizes of the perforations 9d and the distances between the perforations 9d and the extreme ends of the slits 9b are varied in accordance with the local variation of the distribution of the tension or the like. In Embodiment 3, the number of the perforations 9d are varied in accordance with the local variation of the distribution of the tension or the like, since the deformability of the peripheries of the perforations 9d can be varied by the number of the perforations 9d.

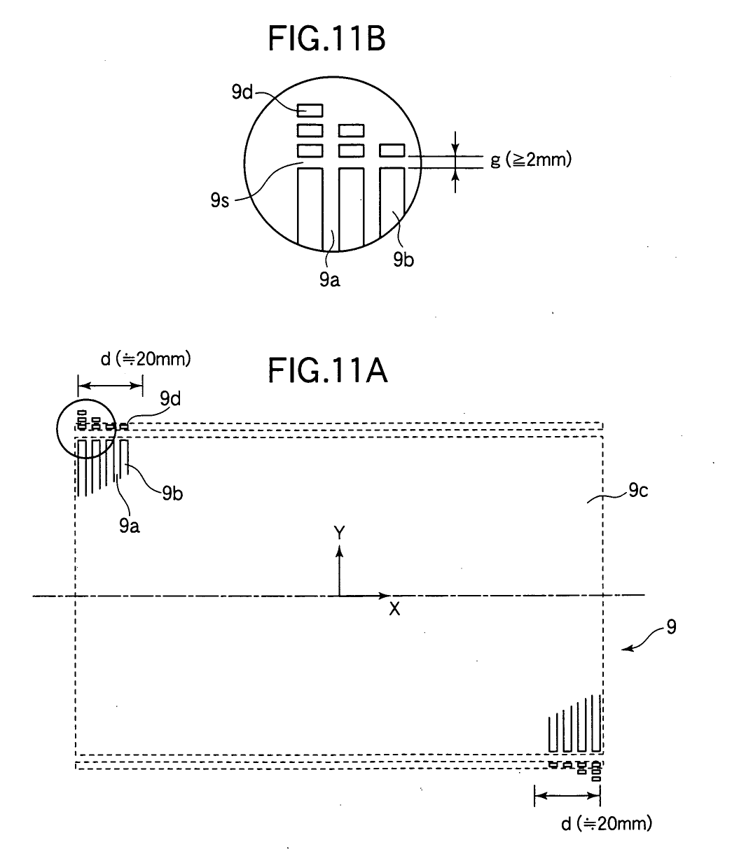

FIG. 11A is a front view of the mask 9 of the strip-type mask assembly for the color cathode ray tube according to Embodiment 3. FIG. 11B is an enlarged view of the extreme ends of the slits 9b (and the strips 9a) as indicated by a circle B in FIG. 11A.

In the mask 9 of Embodiment 3, one or more perforations 9d are aligned with each slit 9b in regions (i.e., left and right areas in FIG. 11A) within 20 mm from the ends of the slit area 9c in the X-direction in which the pitch unevenness is likely to occur. In the case where a plurality of the perforations 9d are aligned with one slit 9b, the distance from the extreme end of the slit 9b to the closest perforation 9d is less than or equal to 2 mm. The other elements are the same as those of Embodiment 1.

Further, it is preferable that a plurality of perforations 9d are aligned with each slit 9b in regions where the pitch unevenness is most likely to occur (i.e., the regions in which large tension is applied as shown in FIG. 4D), so as to increase the effect of relieving the stress caused by the tension. The number of perforations 9d is determined by the tension on the strip 9a so as to maximize the effect of relieving the stress (caused by the tension) on the strip 9a in order to reduce the pitch unevenness.

As described above, according to the strip-type mask assembly of Embodiment 3, the number of the perforations 9d is determined in accordance with the tension on the strips 9a, and therefore it is possible to reduce the difference ΔP among the shrinkage forces of the strips 9a and to reduce the bending moments M applied to the strips 9a. Thus, in addition to the advantages of Embodiment 1, the pitch unevenness can be further suppressed.

Embodiment 4

In the above described Embodiment 2, the sizes of the perforations 9d and the distances between the perforations 9d and the extreme ends of the slits 9b are varied in accordance with the local variation of the distribution of the tension or the like. In the case where the sizes of the perforation 9d are varied, if the electron beam 11 passing through the perforations 9d reach the phosphor screen 2, the shadows of the partitions 9s may appear as black lines on the phosphor screen 2. The black lines appearing on the phosphor screen 2 are not visibly recognized if the black lines are thin and short. However, if the black lines are thick and long, the black lines may be visibly recognized. There is a possibility that such black lines may appear on the phosphor screen 2 also in Embodiments 1 and 3. Thus, in Embodiment 4, the limitation on the sizes of at least one of the perforations 9d is determined to prevent the shadows of the partitions 9s from appearing on the phosphor screen 2 as black lines.

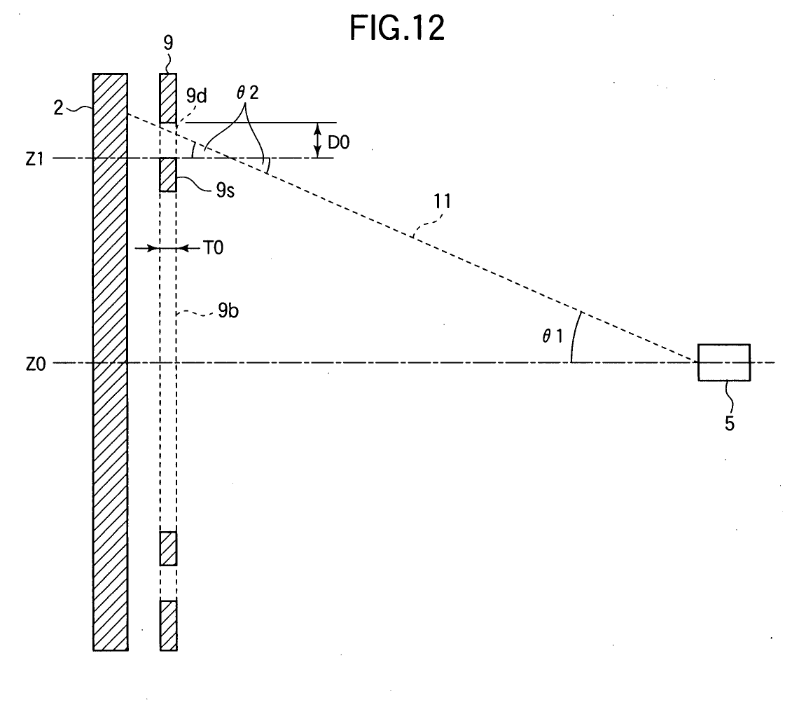

FIG. 12 is a cross sectional view showing the relationship between one electron beam 11 and one of perforations 9d of the strip-type mask assembly for the color cathode ray tube of Embodiment 4.

The electron beam 11 emitted from the electron gun 5 at an angle θ₁ with respect to the tube axis Z0 enters into the perforation 9d of the mask 9 at a different angle after deflected by the magnetic field generated by the deflection yoke 8 shown in FIG. 1. The angle at which the electron beam 11 enters into the perforation 9d (i.e., an incident angle with respect to an axis Z1 parallel to the tube axis Z0) is indicated as θ₂. The thickness of the mask 9 is indicated as T0. The perforation 9d is in the shape of rectangle as shown in FIG. 2. The dimension D0 of the perforation 9d in the Y-direction is limited in accordance with the thickness T0 of the mask 9 so that the electron beam 11 does not pass through the perforation 9d.

Assuming that the mask 9 is flat and perpendicular to the tube axis Z0, the dimension D0 of the perforation 9d that does not allow the passage of the electron beam 11 satisfies the following relationship (1):

D0≦T0 tan θ₂ (1)

The other elements of Embodiment 4 are the same as those of Embodiment 1.

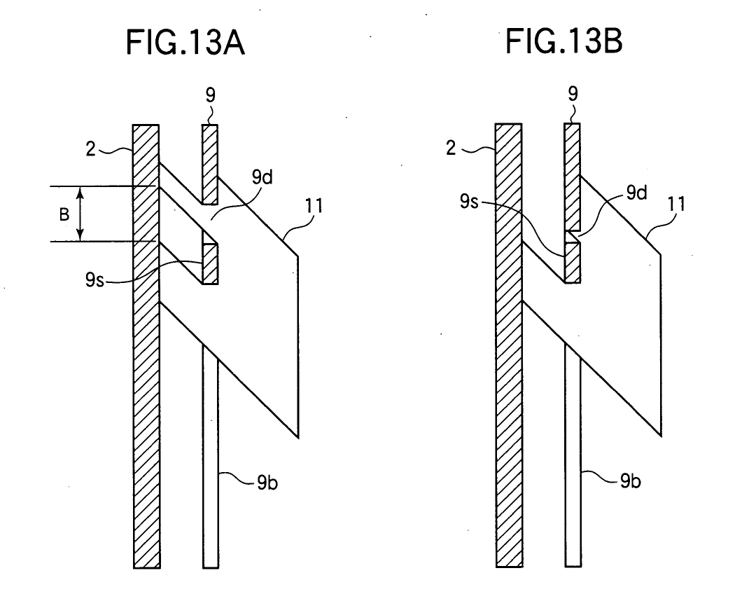

FIGS. 13A and 13B are enlarged cross sectional views of a portion of the mask 9 including the perforation 9d shown in FIG. 12. FIG. 13A illustrate the perforation 9d of a dimension that allows the passage of the electron beam 11. FIG. 13B illustrate the perforation 9d of a dimension that does not allow the passage of the electron beam 11 in association with the thickness of the mask 9.

In FIG. 13A, the perforation 9d has a relatively large dimension in the Y-direction and does not satisfy the relationship (1), with the result that that the electron beam 11 enters into the perforation 9d at an angle (θ₂ in FIG. 12), passes through the perforation 9d and reaches the phosphor screen 2. As the electron beam 11 is incident on the peripheral portion of the phosphor screen 2, the shadow of the partition 9s appears as a black line B on the phosphor screen 2.

In FIG. 13B, the perforation 9d has a relatively small dimension in the Y-direction and satisfy the relationship (1), with the result that the electron beam 11 does not path through the perforation 9d because of the thickness T0 of the mask 9, and therefore the electron beam 11 does not reach the phosphor screen 2. Accordingly, the shadow of the partition 9s does not appear as a black line on the phosphor screen 2.

In Embodiment 4, the shape of the perforation 9d is rectangular, and the dimension D0 is limited in the longitudinal direction of the slit 9b. However, even when the perforation 9d has other shape than rectangle, or even when the dimension of the perforation 9d in different direction is to be limited, the dimension of the perforation 9d can be limited in accordance with the incident angle θ₂ of the electron beam 11, the thickness T0 of the mask 9, and the cross sectional profile of the perforation 9d.

As described above, according to the strip-type mask assembly of Embodiment 4, the dimension of the perforation 9d is limited so that the electron beam 11 does not pass through the perforation 9d and does not reach the phosphor screen 2, and therefore it is possible to prevent the visible black line from appearing in the upper portion or the lower portion of the phosphor screen 2. Even when the dimension of the perforation 9d is limited, the effect of the perforation 9d described in the previous Embodiments 1 through 3 can be obtained by adjusting the position of the perforation 9d with respect to the slit 9b.

Embodiment 5

In the above described Embodiments 1 through 4, the pitch unevenness is suppressed by providing at least one perforation 9d so that the distance from the extreme end of the corresponding slit 9b to the perforation 9d is within 2 mm. Further, in Embodiments 1 through 4, the slits 9b are in the shape of elongated rectangles, and the strips 9a have no protrusion protruding into the slits 9b. However, each of the strips 9a may have one or more protrusions protruding from both longitudinal sides of each strip 9a. The protrusion is provided for preventing the strips 9a from being entangled with each other when the strips 9a are slackened because of thermal expansion due to the incidence of the electron beams of large current. The protrusions of adjacent strips 9a are in contact with each other when the strips 9a are slackened, so as to prevent the line contact and the surface contact between the strips 9a. Hereinafter, the description is made to the mask 9 in which each strip 9a has protrusions on both longitudinal sides thereof so that the protrusions of the adjacent strips 9a oppose each other.

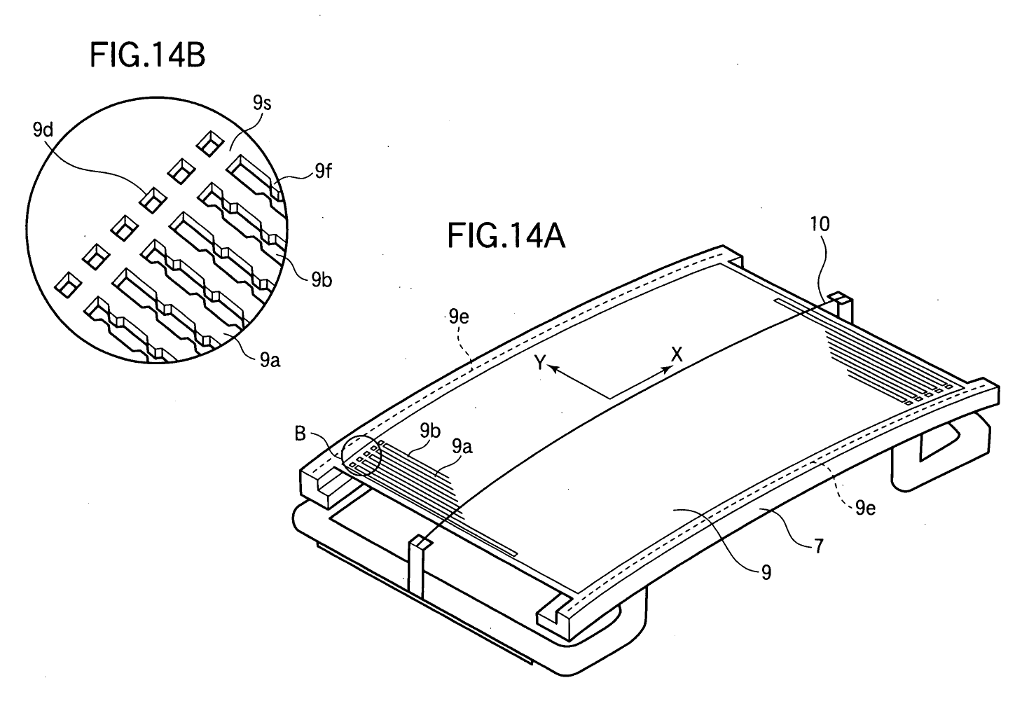

FIG. 14A is a perspective view of a strip-type mask assembly for the color cathode ray tube of Embodiment 5, including the mask 9 and the mask frame 7 supporting the mask 9. FIG. 14B is an enlarged view of the extreme ends of the slits 9b (and the strips 9a) as indicated by a circle B in FIG. 14A.

As shown in FIG. 14A, each of the strips 9a has one or more protrusions 9f protruding into the slit 9b from the longitudinal side of the strip 9a. The protrusions 9f protruding into the same slit 9b from the adjacent strips 9a oppose each other and are in the same position in the Y-direction. The protrusions 9f are provided for preventing the strips 9a from being entangled with each other when the strips 9a are slackened because of thermal expansion due to the incidence of the electron beams of large current. The other elements are the same as those of Embodiment 1.

The protrusion 9f has dimensions sufficient for preventing the line contact of the slackened strips 9a when thermal expansion occurs. In other words, when the strips 9a are slackened, the strips 9a are in point contact with each other without being in line contact with each other. The dimension of each protrusion 9f is at a level that does not affect the amount of the electron beams 11 passing through the slits 9b, and does not affect the brightness of the color cathode ray tube. The dimension of each protrusion 9f is at a level that the opposing protrusions 9f do not contact with each other only by the vibration transferred from outside. This is because, if the protrusions 9f are large enough to allow the protrusions 9f to contact with each other only by the vibration transferred from outside, the strips 9a may be entangled with each other when the strips 9a are slackened because of thermal expansion.

As described in the previous Embodiments 1 through 4, the variation of the width of the slits 9b and the variation of the width of the strips 9a are suppressed by the provision of the perforations 9d. Thus, the gaps between the opposing protrusions 9f of the adjacent strips 9a are kept constant. Consequently, the provision of the perforations 9d has a preferable effect on the prevention of the entanglement of the strips 9a with the protrusions 9f without ill effect.

As described above, according to Embodiment 5, even in the strip-type mask assembly in which the strips 9a have the protrusions 9f protruding into the slits 9b, the pitch unevenness can be suppressed by the provision of the perforation 9d as described in the previous Embodiments 1 through 4.

Embodiment 6

In the above described Embodiments 1 through 5, the pitch unevenness is suppressed by providing at least one perforation 9d so that the distance from the extreme end of the corresponding slit 9b to the perforation 9d is within 2 mm. The shape of the perforation 9d is not limited to the elongated rectangle, but can be a circle, a polygon such as a quadrilateral (for example, a square or a rhombus), or the like. In Embodiment 6, the perforation 9d has a circular shape or a rhomboid shape.

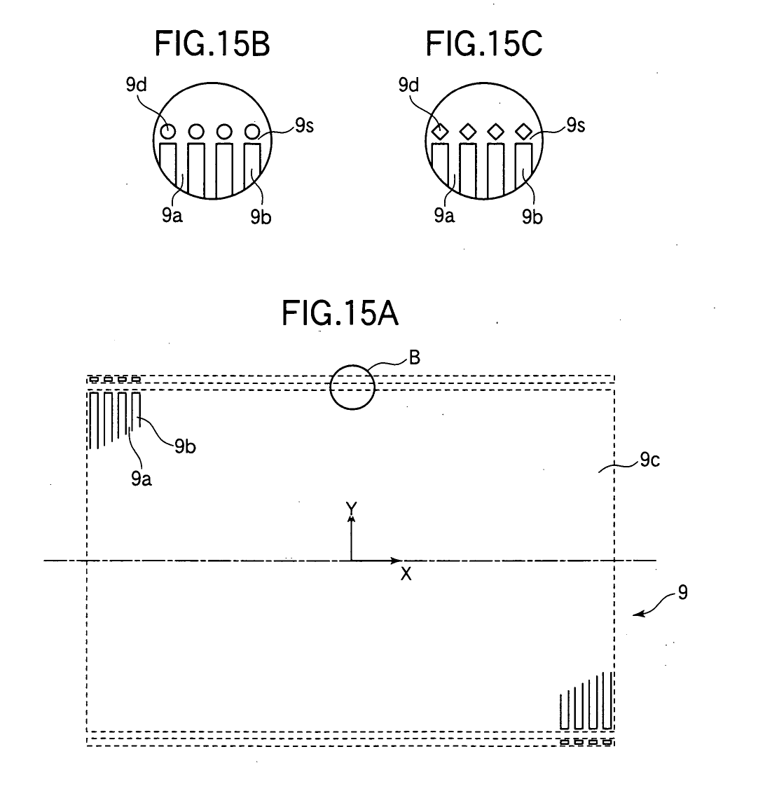

FIG. 15A is a front view of the mask 9 of a strip-type mask assembly for the color cathode ray tube of Embodiment 6. FIG. 15B is an enlarged view of the extreme ends of the slits 9b (and the strips 9a) and circular perforations 9d as indicated by a circle B in FIG. 15A. FIG. 15C is an enlarged view of the extreme ends of the slits 9b (and the strips 9a) and rhomboid perforations 9d as indicated by a circle B in FIG. 15A.

In FIG. 15B, the diameter of the circular perforation 9d is substantially the same as the width of the slit 9b. In FIG. 15C, the diagonal dimension of the rhomboid perforation 9d is substantially the same as the width of the slit 9b.

By comparing the FIGS. 15B and 15C with the figures of Embodiments 1 through 5, it is presumed that the shape of the perforations 9d affect the difference ΔP among the shrinkage forces of the strips 9a in the X-direction and the bending moments acting on the strips 9a. However, the deformability of the periphery of the perforation 9d can be adjusted so that the stress can be relieved by the perforation 9d for preventing the pitch unevenness, as was described in the previous Embodiments 1 through 5.

As described above, according to the strip-type mask assembly of Embodiment 6 having the perforation 9d in the shape of a circle, rhomboid or the like, the pitch unevenness can be suppressed as was described in Embodiments 1 through 5.

Further, it is also possible to vary the dimensions (for example, in the Y-direction) of the circular or rhombus perforations 9d so as to suppress the pitch unevenness as in Embodiment 2.

While the preferred Embodiments of the present invention have been illustrated in detail, it should be apparent that modifications and improvements may be made to the invention without departing from the spirit and scope of the invention as described in the following claims.

What is claimed is:

1. A strip-type mask assembly for a color cathode ray tube comprising:
a color selection mask having a plurality of parallel slits for the passage of electron beams and a plurality of strips separating said slits from each other; and
a mask frame that supports said color selection mask in such a manner that said mask frame applies tension to said color selection mask, said color selection mask being welded to said mask frame at weld positions on both ends of said color selection mask in the longitudinal direction of said slits,
wherein said color selection mask has at least one perforation aligned with at least one of said slits in said longitudinal direction, said at least one perforation is provided in at least one of regions between extreme ends of said slits and said weld positions to form a partition between each perforation and an extreme end of the corresponding slit, and the dimension of each partition in said longitudinal direction is less than or equal to 2 mm.

2. The strip-type mask assembly for the color cathode ray tube according to claim 1, wherein said color selection mask has a plurality of perforations aligned with a plurality of slits, and the dimensions of said perforations or the dimensions of said partitions are varied so as to decrease the difference among widths of said slits.

3. The strip-type mask assembly for the color cathode ray tube according to claim 1, wherein said color selection mask has a slit region in which said slits and said strips are formed, said color selection mask has a plurality of perforations aligned with a plurality of slits disposed in areas in said slit region within substantially 20 mm from an end of said slit region in the direction perpendicular to said longitudinal direction.

4. The strip-type mask assembly for the color cathode ray tube according to claim 1, said perforation has a dimension that does not allow the passage of electron beam that enters into said perforation at an angle larger than a predetermined angle with respect to a tube axis of said color cathode ray tube.

5. The strip-type mask assembly for the color cathode ray tube according to claim 1, wherein said strips have protrusions protruding into said slits in such a manner that opposing protrusions protruding from adjacent strips into the same slit are at the same position in said longitudinal direction as each other, said opposing protrusions protruding from adjacent strips into the same slit are in point contact with each other when said color selection mask thermally expands.

6. The strip-type mask assembly for the color cathode ray tube according to claim 1, wherein said distance between said perforation and said extreme end of said slit is greater than or equal to 0.03 mm.

7. The strip-type mask assembly for the color cathode ray tube according to claim 1, wherein the dimension of said perforation in the direction perpendicular to said longitudinal direction is substantially the same as the width of said slit.

8. The strip-type mask assembly for the color cathode ray tube according to claim 7, wherein said perforation is in the shape of a rectangle, and the width of said perforation in the direction perpendicular to said longitudinal direction is substantially the same as the width of said slit.

9. The strip-type mask assembly for the color cathode ray tube according to claim 7, wherein said perforation is in the shape of a circle having a diameter substantially the same as the width of said slit.

10. The strip-type mask assembly for the color cathode ray tube according to claim 7, wherein said perforation is in the shape of a rhombus having a diagonal in the direction perpendicular to said longitudinal direction which is substantially the same as the width of said slit.

11. The strip-type mask assembly for the color cathode ray tube according to claim 7, wherein dimensions of said perforations in said longitudinal direction are varied so as to decrease the difference among widths of said slits.
